(19) United States
(12) Patent Application Publication
(10) Pub. No.: US 2015/0083543 A1
(43) Pub. Date: Mar. 26, 2015

(54) RELEASE MECHANISM FOR A FRICTION CLUTCH

(71) Applicant: TOYOTA JIDOSHA KABUSHIKI KAISHA, Toyota-shi (JP)

(72) Inventors: Seitaro NOBUYASU, Toyota-shi (JP); Yuji IWASE, Toyota-shi (JP); Yosuke SUZUKI, Toyota-shi (JP); Koichi KATO, Toyota-shi (JP); Kensei HATA, Toyota-shi (JP); Taro MOTEKI, Toyota-shi (JP)

(73) Assignee: TOYOTA JIDOSHA KABUSHIKI KAISHA, Toyota-shi (JP)

(21) Appl. No.: 14/496,112

(22) Filed: Sep. 25, 2014

(30) Foreign Application Priority Data
Sep. 26, 2013 (JP) 2013-199986

(51) Int. Cl. F16D 25/0635

(52) U.S. Cl. CPC F16D 25/0635
USPC 192/85.01

(57) ABSTRACT

A clutch release mechanism shortened in its axial length. The clutch release mechanism is applied to a friction clutch 5 engaged to transmit a torque between a rotary output member 4 and a rotary input member 2, 11. A hydraulic actuator 26 generates a hydraulic pressure to reduce a pushing force applied to the friction clutch. A plurality of elastic members 27 are arranged annularly around a rotational center axis while keeping predetermined intervals. An oil passage 33 is communicated with the hydraulic actuator 26 while passing through the interval.

The present invention claims the benefit of Japanese Patent Application No. 2013-199986 filed on Sep. 26, 2013 with the Japanese Patent Office, the disclosure of which is incorporated herein by reference in its entirety

### BACKGROUND

1. Field of the Invention

The present invention relates to the art of a release mechanism for disengaging a friction clutch engaged by a diaphragm spring by applying a load to the diaphragm spring according to a hydraulic pressure delivered to an actuator.

2. Discussion of the Related Art

One example of the release mechanism is disclosed in JP-A-2001-50295. According to the teachings of JP-A-2001-50295, a hydraulic actuator is arranged around an input shaft of a transmission, and a piston of the actuator is fitted onto the input shaft while being allowed to move in an axial direction of the input shaft. In order to push the piston toward a diaphragm spring, an oil pressure is delivered to a hydraulic chamber formed on an opposite side of the diaphragm spring across the piston. To this end, the piston is connected with an inner race of a relief bearing, and an inner circumferential portion of the diaphragm spring is connected with an outer race of the relief bearing. In order to push the piston and the return spring away from the diaphragm spring, a return spring for establishing a pushing force in the axial direction is arranged around the hydraulic actuator. Accordingly, when the oil pressure is delivered to the hydraulic chamber, the piston and the relief bearing are moved toward the diaphragm spring against the pushing force of the return spring, thereby pushing the inner circumferential portion of the diaphragm spring.

Meanwhile, JP-A-9-303423 discloses a spring retainer comprising a bottomed-cylindrical piston bore formed between a shaft and a housing. In the bore, a piston is arranged in the bottom side while being allowed to move in an axial direction of the shaft. A cancel plate is arranged to be opposed to the piston, and a backward movement of the cancel plate is restricted. In addition, a plurality of coil springs are arranged between the piston and the cancel plate, and a multiple plate clutch is arranged in the opposite side of the piston across the cancel. According to the teachings of JP-A-9-303423, therefore, the multiple plate clutch is engaged by delivering fluid between the bore and the piston thereby moving the piston toward the cancel plate against the elastic forces of the coil springs.

In turn, JP-A-2010-112529 discloses an automatic transmission in which a plurality of brakes are arranged in an axial direction of an input shaft of the transmission, and in which a plurality of return springs are arranged in an outer circumferential side of friction plates of the brakes. Each brake is individually provided with a piston situated between the friction plates and a casing of the transmission, and a hydraulic chamber to which fluid is delivered. According to the teachings of JP-A-2010-112529, therefore, the brake is engaged by delivering fluid to a hydraulic chamber from a diametrically inner side, thereby moving the piston in the axial direction of the input shaft toward the friction plates against elastic forces of the return springs.

Thus, in the release mechanism taught by JP-A-2001-50295, the return spring is arranged around the hydraulic actuator, and an oil passage for delivering the fluid to the hydraulic chamber is formed while detouring the return spring. Therefore, a length of the release mechanism has to be elongated in the axial direction. In addition, since the return spring is arranged around the hydraulic actuator, a diametrical dimension of the release mechanism may also be increased.

The diametrical dimension of the release mechanism taught by JP-A-2001-50295 may be reduced by arranging the coil springs taught by JP-A-9-303423 or JP-A-2010-112529 around the hydraulic actuator instead of the return spring. However, if those coil springs are arranged in the same axial position as the return spring, the oil passage for delivering the fluid to the hydraulic chamber is still has to be formed in a manner to detour those coil springs. Therefore, the axial length of the release mechanism may not be shortened,

### SUMMARY OF THE INVENTION

The present invention has been conceived noting the above-mentioned technical problems, and it is therefore an object of the present invention is to provide a release mechanism for a friction clutch in which an axial length is shortened.

The release mechanism according to the present invention is applied to a friction clutch that is constantly pushed in an axial direction to be engaged to transmit a torque between a rotary output member and a rotary input member. In the release mechanism, a hydraulic actuator that is formed to establish a hydraulic pressure in the axial direction in a manner such that a pushing force applied to the friction clutch is reduced, and a plurality of elastic members are arranged annularly around a rotational center axis in a manner to establish an elastic force in the axial direction. In order to achieve the above-explained object, according to the release mechanism of the present invention, a predetermined interval is maintained between the adjacent elastic members, and an oil passage is formed to be communicated with the hydraulic actuator while passing through the interval.

A width of the oil passage in a circumferential direction is identical to or slightly shorter than the interval between the adjacent elastic members.

The friction clutch is comprised of a pushing member for applying a pushing force constantly to the friction clutch in the axial direction toward the output rotary member. Specifically, the plurality of elastic members are arranged in a manner such that a net force of the elastic forces thereof is applied homogeneously or equally to the pushing member around the rotational center.

For example, a diaphragm spring is employed as the pushing member. According to the present invention, both of a load resulting from the hydraulic pressure established by the hydraulic actuator, and the net force of the elastic forces of the elastic members are applied to an inner circumferential portion of the diaphragm spring.

More specifically, the plurality of elastic members are arranged in a symmetric manner with respect to a predetermined line extending perpendicular to the rotational center axis.

Thus, according to the present invention, the predetermined interval, that is a predetermined clearance is maintained between the adjacent elastic members, and the oil passage is formed in a manner to be communicated with the hydraulic actuator while passing through the interval. Specifically, the oil passage is formed in a manner to be overlapped at least partially with the elastic member in the axial direction. Therefore, an axial length of the release mechanism can be shortened, in other words, a thickness of the release mechanism can be thinned.

Since a plurality of the elastic members are arranged annularly around a rotational center axis, a diameter of each elastic member can be reduced in comparison with a case of using one elastic member. In addition, a width of the oil passage in a circumferential direction is identical to or slightly shorter than the interval between the adjacent elastic members. Therefore, the oil passage is allowed to be formed without detouring unnecessarily around the elastic member while passing through the interval between the elastic members. For this reason, the axial length of the release mechanism can be shortened, that is, the thickness of the releasing mechanism can be reduced.

In addition, since a plurality of the elastic members are thus arranged annularly around a rotational center axis, the net force of the elastic forces thereof can be applied homogeneously to the pushing member around the rotational center. Therefore, members forming the release mechanism will not be inclined or collide with each other due to imbalance of the elastic forces.

As described, the diaphragm spring is used as the pushing member to which the load and the elastic forces are applied for pushing the friction clutch. Therefore, a thickness of the release mechanism in the axial direction can be reduced.

As also described, specifically, the plurality of elastic members are arranged in a symmetric manner with respect to a predetermined line extending perpendicular to the rotational center axis. Therefore, the elastic forces of the elastic members can be applied homogeneously to the friction clutch around the rotational center. In addition, the members forming the release mechanism can be prevented from being inclined or collide with each other.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a sectional side view showing one example of the release mechanism according to the present invention;

FIG. 2 is a cross-sectional view along the line II-II shown in FIG. 1;

FIG. 3 is a cross-sectional view along the line III-III shown in FIG. 2;

FIG. 4 is a view showing another example of the release mechanism according to the present invention;

FIG. 5 is a view showing an example to partially modify the release mechanism shown in FIG. 4;

FIG. 6 is a view showing still another example of the release mechanism according to the present invention;

FIG. 7 is a view showing an example to partially modify the release mechanism shown in FIG. 6;

FIG. 8 is a view showing an example of a power train of the vehicle to which the release mechanism of the present invention is applied;

FIG. 9 is a view showing another example of a power train of the vehicle to which the release mechanism of the present invention is applied; and

FIG. 10 is a view showing still another example of a power train of the vehicle to which the release mechanism of the present invention is applied.

### DETAILED DESCRIPTION OF THE PREFERRED EMBODIMENT(S)

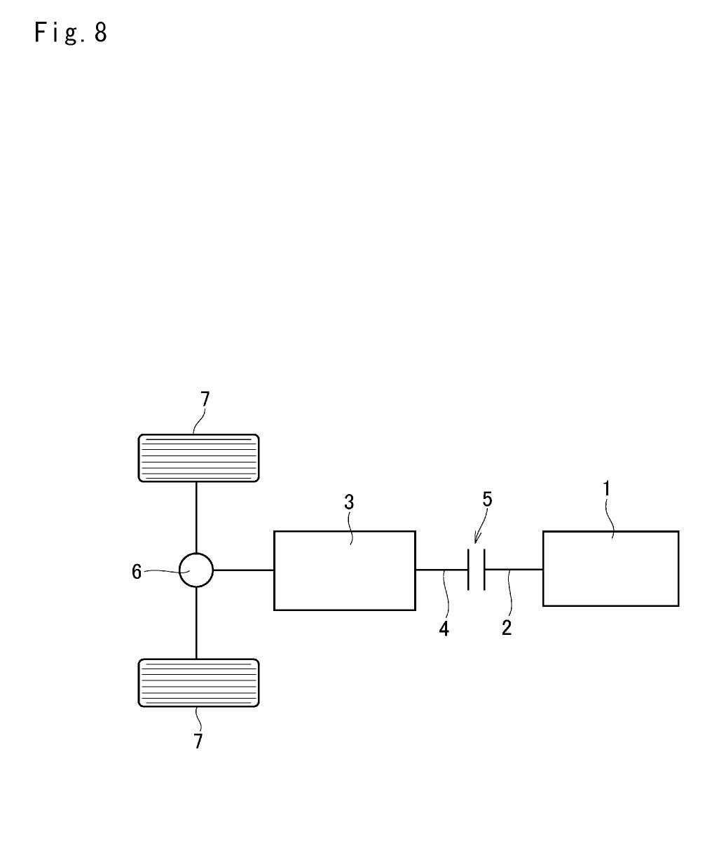

Next, the present invention will be explained in more detail with reference to the accompanying drawings. FIG. 8 is a view showing an example of a power train of the vehicle to which the release mechanism of the present invention is applied. As can be seen from FIG. 8, a clutch 5 is interposed between a crankshaft 2 serving as an output shaft of an engine 1 and an input shaft 4 of a transmission 3. Therefore, a torque is allowed to be transmitted between the engine 1 and the transmission 3 by engaging the clutch 5. In addition, a pair of driving wheels 7 is connected with an output side of the transmission 3 through a differential gear unit 6.

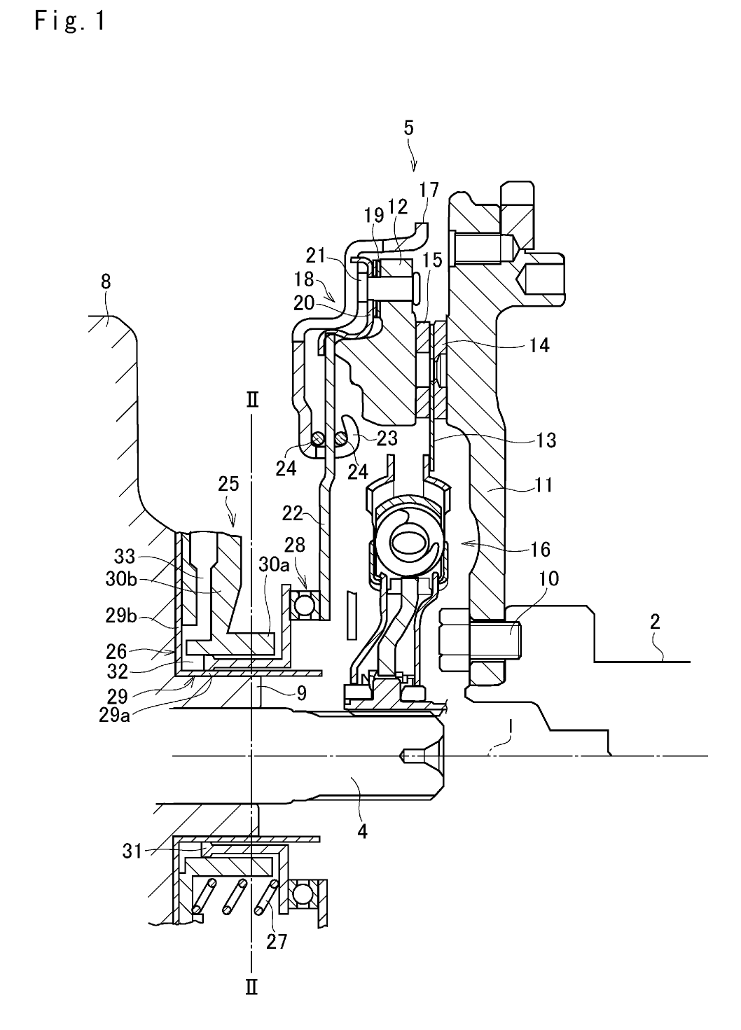

FIG. 1 is a sectional side view of the release mechanism of the present invention and the clutch 5. As can be seen from FIG. 1, the clutch 5 is arranged between the engine 1 and a housing 8 of the transmission 3. A protrusion 9 is formed on the housing 8 while protruding toward the engine 1 in the axial direction of the input shaft 4 of the transmission 3, and the after mentioned release mechanism 25 is fitted onto the protrusion 9. Here, the broken line I in FIG. 1 represents an axial center of the input shaft 4 of the transmission 3. For example, a dry-type clutch in which oil is not interposed between engagement surfaces is used as the clutch 5, and the crankshaft 2 of the engine 1 is selectively connected with the input shaft 4 of the transmission 3 to transmit the torque therebetween by engaging the clutch 5. Specifically, a flywheel 11 is attached to the crankshaft 2 by a bolt 10, and an annular pressure plate 12 is opposed to a face of the flywheel 11 of the transmission 3 side. A clutch disc 13 is interposed between the flywheel 11 and the pressure plate 12. As can be seen, the clutch disc 13 is comprised of a first friction member 14 facing toward the flywheel 11, and a second friction member facing toward the pressure plate 12.

The clutch disc 13 is connected with the input shaft 4 through a torsional damper 13 to transmit a torque. The torsional damper 13 is a conventional damper adapted to damp torque pulses caused by firing impulse of the engine 1. Accordingly, the crankshaft 2 and the flywheel 11 serve as the input side rotary member of the present invention, and the input shaft 4 of the transmission 3 serves as the output side rotary member of the present invention.

In the clutch 5 thus structured, a friction acting between the first friction member 14 and the flywheel 11, and a friction acting between the second friction member 15 and the pressure plate 12 are increased by increasing a pressure to clamp the clutch disc 13 by the pressure plate 12 and the flywheel 11. Consequently, the clutch 5 is engaged so that the crankshaft 2 is connected with the input shaft 4 in a manner to transmit torque. By contrast, the friction acting between the first friction member 14 and the flywheel 11, and the friction acting between the second friction member 15 and the pressure plate 12 are reduced by lowering a pressure to clamp the clutch disc 13 by the pressure plate 12 and the flywheel 11. Consequently; the crankshaft 2 is disconnected from the input shaft 4 so that the clutch 5 is disengaged.

The pressure plate 12 is covered by a clutch cover 17 attached to the flywheel 11 by a not shown bolt or the like. Specifically, the clutch cover 17 is adapted to cover the pressure plate 12 from the transmission 13 side and from the outer circumferential side, and a plurality of hole 18 are formed on the clutch cover 17 at predetermined intervals in the circumferential direction. In order to retain the after-mentioned diaphragm spring 22, a retainer member 20 is interposed between the clutch cover 17 and the pressure plate 12. The retainer member 20 and one of the end portions of a strap plate 19 are fixed to a face of the pressure plate 12 facing to the transmission 3 by a rivet 21. Likewise, the other end portion of the strap plate 19 is fixed to an inner face of the clutch cover 17 by the rivet 21. Thus, the pressure plate 12 and the clutch covert 17 are connected with each other through the strap plate 19. Therefore, an elastic force of the strap plate 19 is applied to the pressure plate 12 in a direction to isolate the pressure plate 12 away from the clutch disc 13.

Specifically, an outer circumferential edge of the diaphragm spring 22 is retained by an inner circumferential edge of the retainer member 20 and the pressure plate 12. Therefore, the portion of the diaphragm spring 22 of outer circumferential side of the after-mentioned pivot ring 24 is moved integrally with the pressure plate 12 in the axial direction of the input shaft 4.

A plurality of hook portions 23 are formed by bending an inner circumferential portion of the clutch cover 17 toward the engine 1 in a manner to orient the leading end portion to the outer circumferential side. As can be seen, two pivot rings 24 individually having circular cross-section are held in an inner space of the hook portion 23 across the diaphragm spring 22.

Specifically, the diaphragm spring 22 is a conventional disc spring member having a plurality of radially inwardly directed spring fingers, and an inner circumferential portion of the diaphragm spring 22 is contacted with a bearing 28 of a release mechanism 25 of the present invention. Therefore, the pressure plate 12 is pushed by an elastic force of the diaphragm spring 22 toward the clutch disc 13 so that the clutch disc 13 is clamped by the pressure plate 12 and the flywheel 11. That is, the clutch 5 is engaged by the elastic force of the diaphragm spring 22. Accordingly, the diaphragm spring 22 serves as the pushing member of the present invention, and the elastic force of the diaphragm spring 22 corresponds to the pushing force of the present invention.

The release mechanism 25 is adapted to apply a load for disengaging the clutch 5 to the inner circumferential portion of the diaphragm spring 22. As can be seen from FIG. 1, the release mechanism 25 is comprised of a hydraulic actuator 26, a return spring 27 and the bearing 28. The hydraulic actuator 26 is comprised of an inner body 29 fitted onto the protrusion 9, and an outer body 30 situated around the inner body 29. Specifically, the inner body 29 is comprised of an inner cylinder 29a extending coaxially with the input shaft 4, and an annular plate 29b extending radially from an end portion of the inner cylinder 29a of the transmission 3 side while being contacted with the housing 8. Meanwhile, the outer body 30 is comprised of an outer cylinder 30a extending coaxially with the input shaft 4 in an outer circumferential side of the inner cylinder 29a, and an annular plate 30b extending radially from an end portion of the outer cylinder 30a of the transmission 3 side, in order to retain the return spring 27, an outer circumferential portion of the annular plate 30b of the outer body 30 is flexed to a substantially right angle. An arrangement of the return springs 27 will be explained later.

A piston 31 is inserted into a cylindrical space created between the inner cylinder 29a and the outer cylinder 30a while being allowed to reciprocate in the axial direction of the input shaft 4. That is, the cylindrical space serves as a hydraulic chamber 32, and an oil passage 33 is connected with the hydraulic chamber 32. Therefore, the piston 31 is hydraulically moved toward the flywheel 11 by delivering the fluid to the hydraulic chamber 32 from a not, shown hydraulic source via the oil passage 33. Specifically, the oil passage 33 is formed to radially penetrate the annular plate 30b in a manner to be situated between the return springs 27 adjacent to each other. Alternatively, the oil passage 33 may also be formed between the inner body 29 and the annular plate 30b in the above-explained manner. In addition, in order to avoid an oil leakage, a sealing member may be disposed on an end portion of the piston 31 of a pressure receiving face side.

The other end portion of the piston 31 is bent radially outwardly, and the above-explained bearing 28 is attached to the bent portion in a manner to be contacted with the inner circumferential portion of the diaphragm spring 22. That is, the piston 31 and the diaphragm spring 22 are allowed to be rotated relatively with each other. Therefore, when the fluid is delivered to the hydraulic chamber 32 so that the piston 31 is moved toward the flywheel 11, a load is applied to the inner circumferential portion of the diaphragm spring 22 according to the hydraulic pressure through the bearing 28 thereby resiliently deforming the spring fingers of the diaphragm spring 22. As a result, the pushing force of the diaphragm spring 22 is reduced so that the clutch 5 is disengaged.

The above-mentioned return springs 27 are arranged on the annular plate 30b of the outer body 30 annularly around the center axis I of the input shaft 4 at predetermined intervals, in a manner to extend in parallel with the center axis I. Specifically, a coil spring is employed as the return spring 27, and each coil springs 27 has a same elastic force, length, wire diameter, outer diameter and etc. That is, one of the end portions of each return spring 27 is individually contacted with the annular plate 30b of the outer body 30, and the other end portion of each return spring 27 is individually contacted with the above-explained bent portion of the piston 31. Therefore, a net force of the elastic forces of the return springs 27 is applied homogeneously or equally around the center axis I to the piston 31 and the bearing 28.

Thus, according to the example shown in FIG. 1, the clutch 5 is disposed between the engine 1 and the transmission 3 in the torque transmitting direction, and the elastic forces of the return springs 27 are applied to the bearing 28 in the same direction as the hydraulic pressure applied to the bearing 28 from the hydraulic actuator 26, thereby pushing the piston 31 and the bearing 28 constantly toward the flywheel 11. Alternatively, the bearing 28 may also be retained by applying the elastic forces of the return springs 27 to the bearing 28 from the opposite direction to the hydraulic pressure applied from the hydraulic actuator 26. Here, provided that the release mechanism of the present invention is applied to a hybrid vehicle which is allowed to be driven by a motor torque while disconnecting the engine from the power train, the elastic forces of the return springs 27 are applied to the bearing 28 in the same direction as the example shown in FIG. 1.

As described, the return springs 27 are arranged in a manner such that the elastic forces thereof are applied homogeneously around the center axis I to the piston 31, the bearing 28 and the diaphragm spring 22. To this end, a unit of springs formed by combining a plurality of springs may also be used as the return spring 27. In this case, the unit of the springs will also be arranged annularly at predetermined intervals. Alternatively, the return springs 27 may also be arranged in a symmetric manner with respect to a predetermined line extending perpendicular to the center axis I. Accordingly, the return spring 27 serves as the elastic member of the present invention.

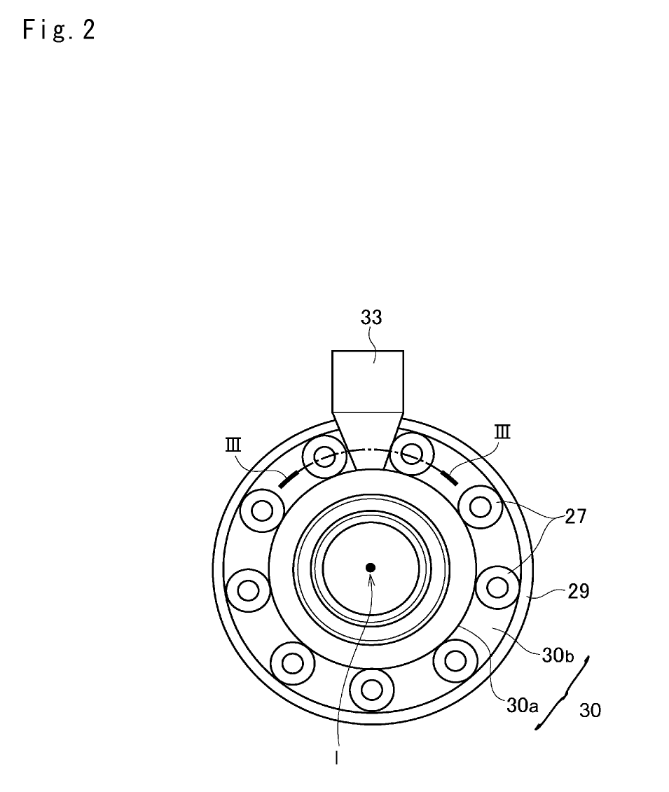

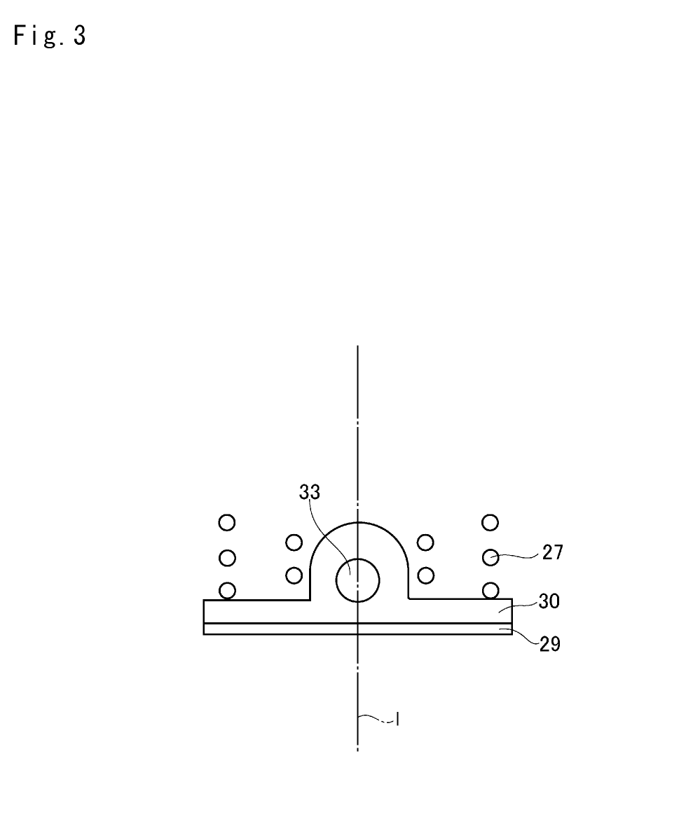

Referring now to FIG. 2, there is shown a cross-sectional view along the line II-II shown in FIG. 1. In the example shown in FIG. 2, nine return springs 27 are arranged in total on the annular plate 30h of the outer body 30 around the outer cylinder 30a at regular intervals, that is, while keeping predetermined intervals. Each return spring 27 is erected in a manner to extend in parallel with the center axis I. In addition, those return springs 27 are arranged in a symmetric manner with respect to a predetermined line extending perpendicular to the center axis I. Therefore, a net force of the elastic forces of the return springs 27 is applied homogeneously around the center axis I to the inner circumferential portion of the diaphragm spring 22. The oil passage 33 is extended while passing through an interval between the return springs 27 adjacent to each other, and a width of the oil passage 33 in a circumferential direction of the annular plate 30b is identical to or slightly shorter than the interval between outer circumferences of the adjacent return springs 27. Referring now to FIG. 3, there is shown a cross-sectional view along the line shown in FIG. 2. As can be seen from FIG. 3, the oil passage 33 is formed in a manner to radially penetrate the annular plate 30b of the outer body 30 at a level within a length of the return springs 27 in the direction of the center axis I.

Thus, in the release mechanism 25, a plurality of the return springs 27 is arranged annularly while keeping predetermined intervals so that the oil passage 33 is allowed to be formed between the adjacent return springs 27. In addition, the oil passage 33 is formed to radially penetrate the annular plate 30b at the level within a length of the return springs 27 in the direction of the center axis I. Therefore, an axial length of the hydraulic actuator 26 can be shortened without detouring the return springs 27 so that a thickness of the release mechanism 25 is reduced. In addition, since the return springs 27 are arranged annularly around the outer cylinder 30a, that is, around the center axis I at predetermined intervals, the net force of the elastic forces created by the return springs 27 is applied homogeneously around the center axis I to the diaphragm spring 22 via the piston 31 and the bearing 28. Therefore, the piston 31 can be prevented from being contacted with the inner cylinder 29a of the inner body 29. Specifically, the bent portion of the piston 31 can be prevented from being inclined to be contacted with the annular plate 30b of the outer body 30. That is, the diaphragm spring 22 can be prevented from being inclined with respect to the center axis I of the input shaft 4 of the transmission 3.

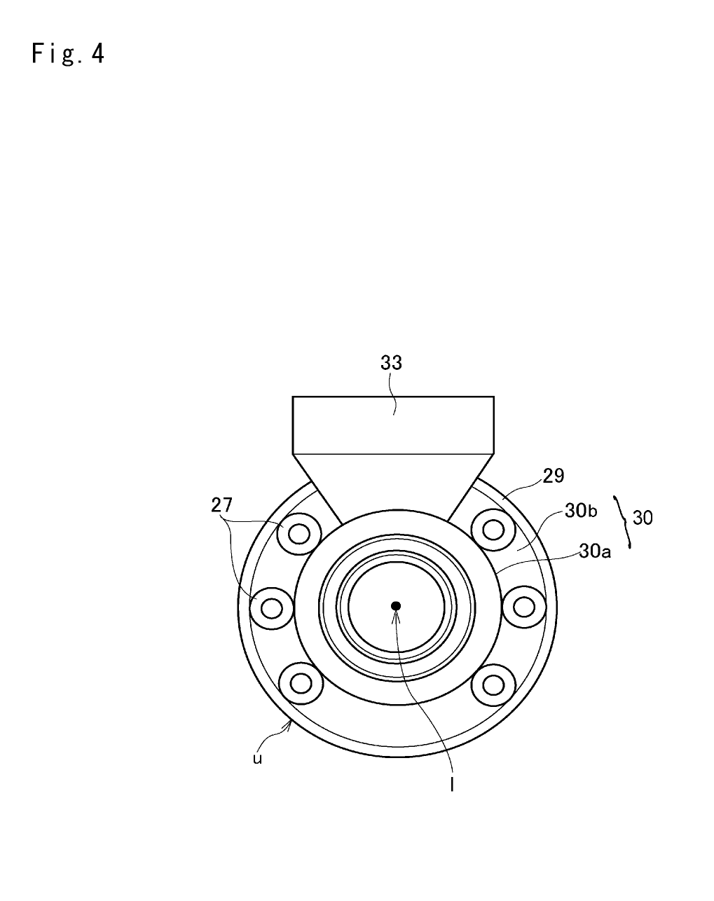

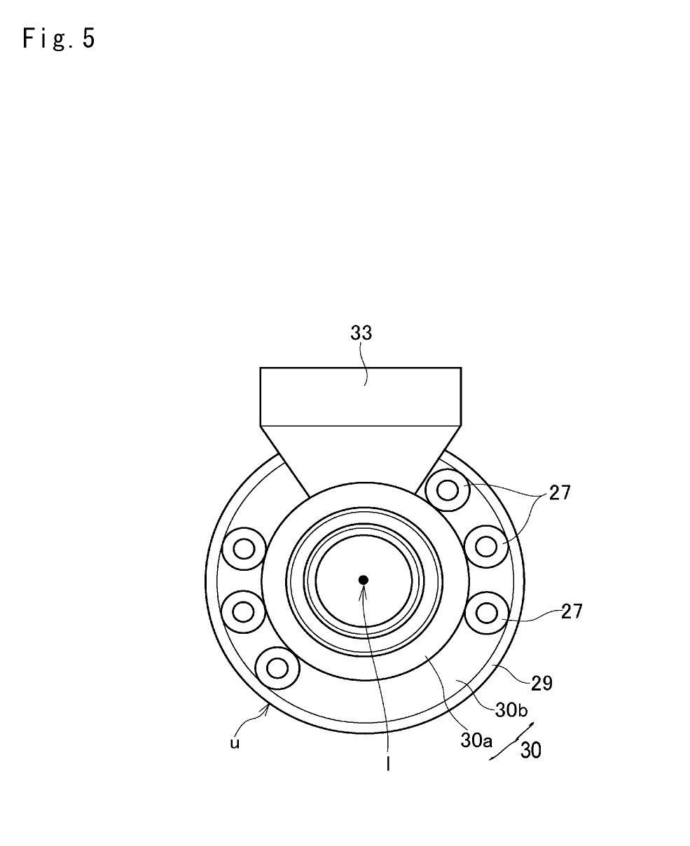

Referring now to FIG. 4, there is shown a cross-section of another example of the release mechanism 25 in which a unit U comprising three return springs 27 is employed. Specifically, in the unit U, the return springs 27 are arranged while keeping predetermined intervals in a manner to extend in parallel with the center axis I. As can be seen from FIG. 4, a pair of units U is arranged on the annular plate 30b around the outer cylinder 30a while keeping predetermined intervals, in a manner such that the return springs 27 are situated in a symmetric manner with respect to a predetermined line extending perpendicular to the center axis I. That is, six return springs 27 are arranged annularly around the center axis I of the input shaft 4. In this example, the oil passage 33 is extended while passing through an interval between the adjacent units U, and a width of the oil passage 33 in a circumferential direction of the annular plate 30b is identical to or slightly shorter than the interval between outer circumferences of the outermost return springs 27 of each unit U adjacent to each other FIG. 5 shows an example to partially modify the release mechanism 25 shown in FIG. 4. As can be seen from FIG. 5, the oil passage 33 may be situated closer to one of the units U arranged in a manner such that the return springs 27 are situated in a symmetric manner with respect to a predetermined line extending perpendicular to the center axis I.

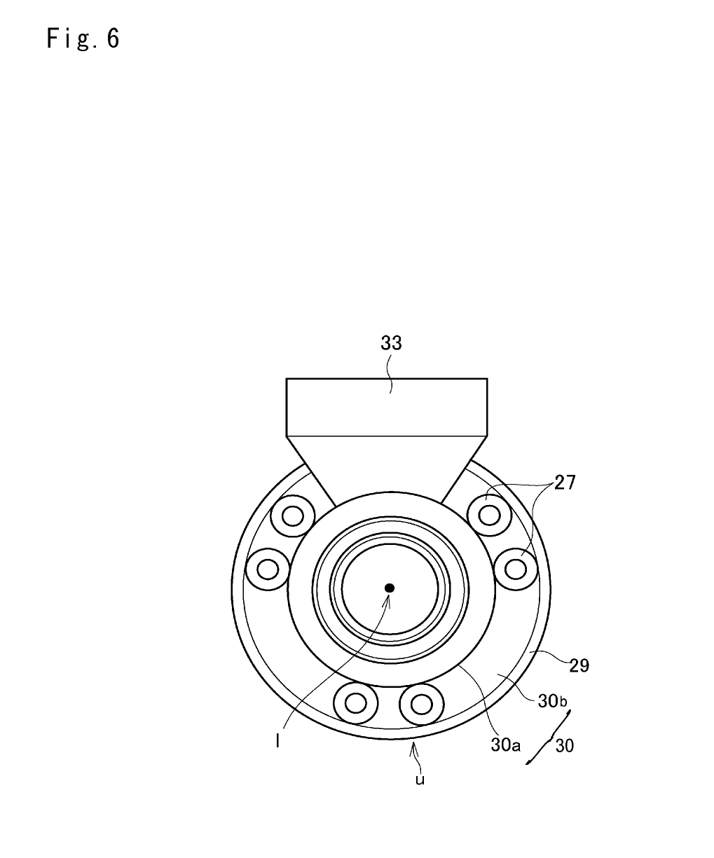

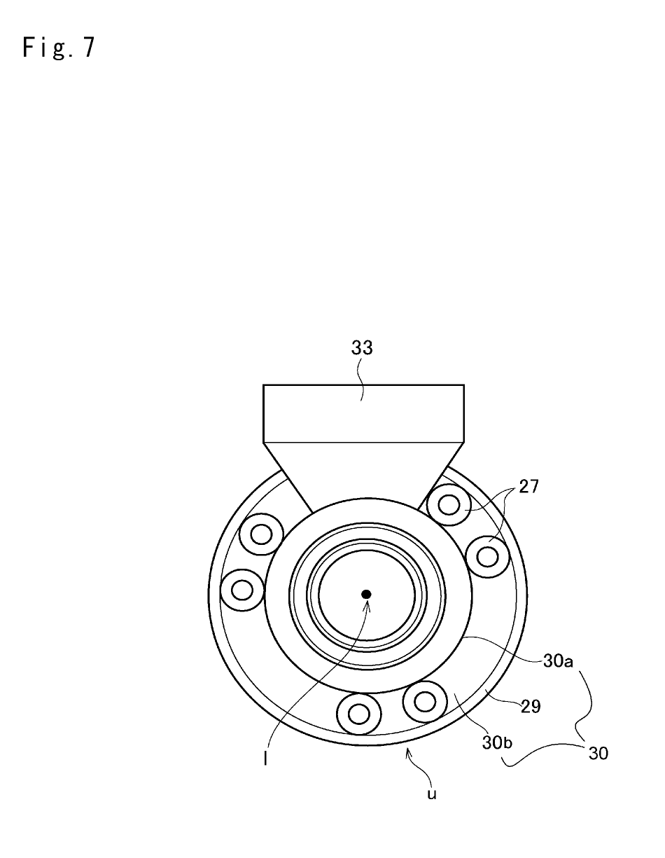

Referring now to FIG. 6, there is shown a cross-section of still another example of the release mechanism 25 in which a unit U comprising two return springs 27 is employed. In this example, the return springs 27 are arranged at a predetermined interval in a manner to extend in parallel with the center axis I. Here, a distance of the interval between the return springs 27 is same in each unit U. As can be seen from FIG. 6, three units U are also arranged on the annular plate 30b around the outer cylinder 30a while keeping predetermined intervals, in a manner such that the return springs 27 are situated in a symmetric manner with respect to a predetermined line extending perpendicular to the center axis I. That is, six return springs 27 are also arranged annularly around the center axis I of the input shaft 4. In this example, the oil passage 33 is also extended while passing through an interval between the adjacent units U, and a width of the oil passage 33 in a circumferential direction of the annular plate 30b is identical to or slightly shorter than the interval between outer circumferences of the return springs 27 of each unit U adjacent to each other, FIG. 7 shows an example to partially modify the release mechanism 25 shown in FIG. 6. As can be seen from FIG. 7, the oil passage 33 may also be situated closer to one of the units U arranged in a manner such that the return springs 27 are situated in a symmetric manner with respect to a predetermined line extending perpendicular to the center axis I.

In the examples shown in FIGS. 4 to 7, the oil passage 33 may be formed in the annular plate 30b at the level within the length of the return springs 27 in the direction of the center axis I. Therefore, the axial length of the hydraulic actuator 26 can be shortened so that the thickness of the release mechanism is reduced, In addition, since the return springs 27 are thus arranged annularly around the outer cylinder 30a, that is, around the center axis I at predetermined intervals, the net force of the elastic forces created by the return springs 27 is also applied homogeneously around the center axis I to the diaphragm spring 22 via the piston 31 and the bearing 28. Therefore, the piston 31 can be prevented from being inclined to be contacted with the inner cylinder 29a of the inner body 29. In addition, the bent portion of the piston 31 can also be prevented from being contacted with the annular plate 30b of the outer body 30. That is, the diaphragm spring 22 can be prevented from being inclined with respect to the center axis I of the input shaft 4 of the transmission 3.

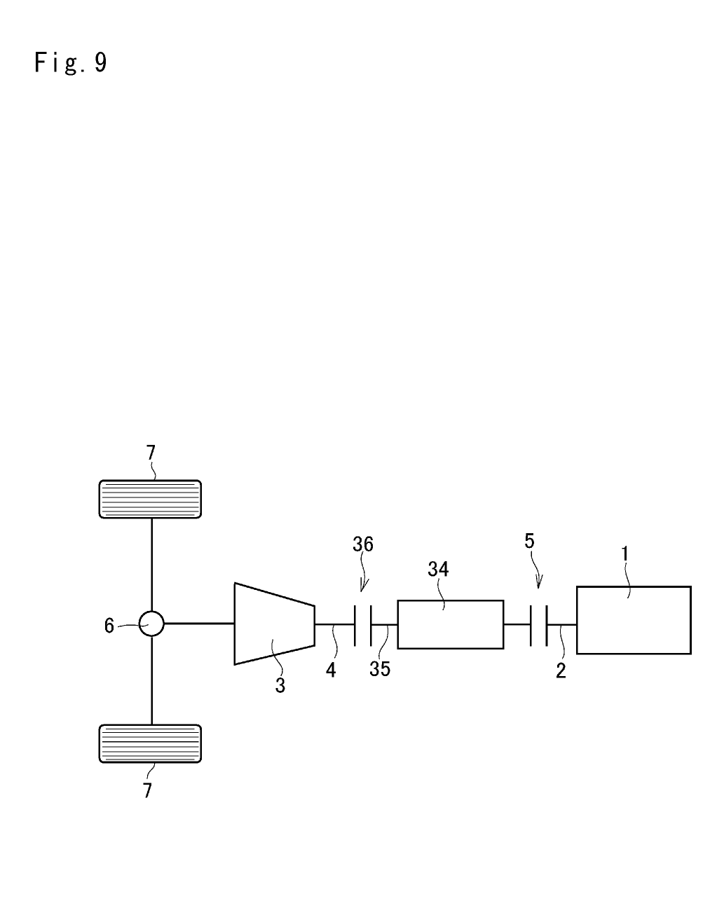

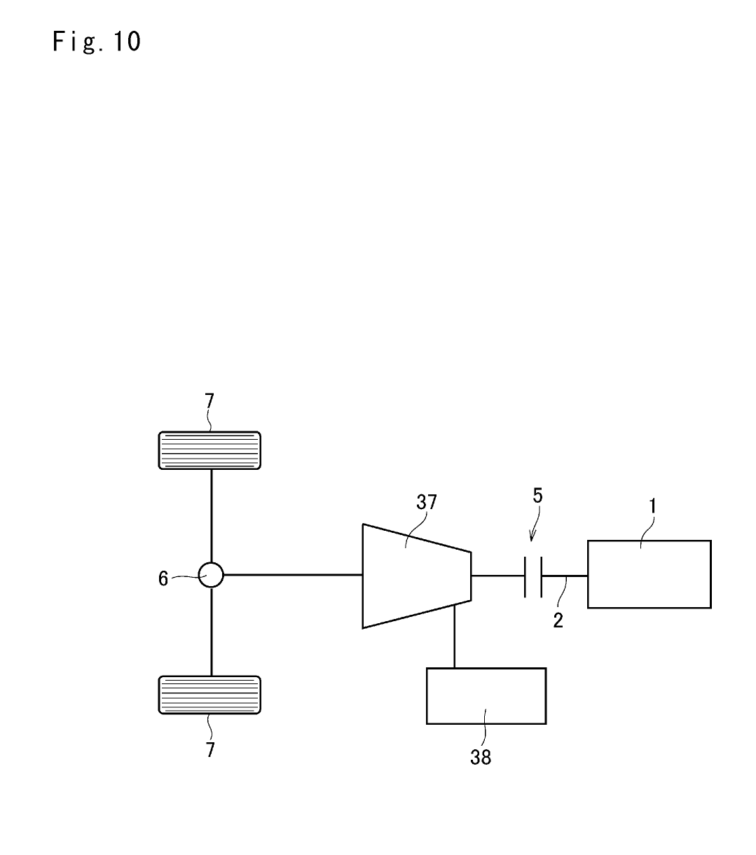

Here will be explained another example of a power train of the vehicle to which the release mechanism 25 of the present invention can be applied, with reference to FIGS. 9 and 10. As can be seen from FIG. 9, a motor-generator 34 is connected with the crankshaft 2 of the engine 1 through the clutch 5. An output shaft 35 of the motor-generator 34 is connected with the input shaft 4 of the transmission 3 through another clutch 36, and the driving wheels 7 are connected with the output side of the transmission 3 through a differential gear unit 6. FIG. 10 shows still another example of a power train of the vehicle to which the release mechanism of the present invention is applied. In the example shown in FIG. 10, a dual-clutch transmission 37 is connected with the crankshaft 2 of the engine 1 through the clutch 5, and the driving wheels 7 are connected with the output side of the dual-clutch transmission 37 through a differential gear unit 6. In addition, another motor-generator 38 is also connected with the dual-clutch transmission 37. Therefore, the hybrid vehicle shown in FIG. 9 or 10 can be driven by a torque of the motor-generator 34 or 38. In this case, a power loss resulting from a concurrent rotation of the engine 1 can be reduced by disengaging the clutch 5, and in this situation, the engine 5 is allowed to be halted. In addition, the hybrid vehicle shown in FIG. 9 or 10 may also be driven by torques of the engine 1 and the motor-generator 34 or 38. In the hybrid vehicle shown in FIG. 9 or 10, a cranking of the engine 1 is carried out by the motor-generator 34 or 38 while engaging the clutch 5.

Although the above exemplary embodiment of the present invention have been described, it will be understood by those skilled in the art that the present invention should not be limited to the described exemplary embodiments, but that various changes and modifications can be made within the spirit and scope of the present invention.

What is claimed is:

1. A release mechanism for a friction clutch that is constantly pushed in an axial direction to be engaged to transmit a torque between a rotary output member and a rotary input member, comprising:
a hydraulic actuator that is adapted to establish a hydraulic pressure in the axial direction in a manner such that a pushing force applied to the friction clutch is reduced;
a plurality of elastic members arranged annularly around a rotational center axis in a manner to establish an elastic force in the axial direction;
a predetermined interval maintained between the adjacent elastic members; and
an oil passage communicated with the hydraulic actuator while passing through the interval.

2. The release mechanism as claimed in claim 1, wherein a width of the oil passage in a circumferential direction is identical to or slightly shorter than the interval between the adjacent elastic members.

3. The release mechanism as claimed in claim 1,
wherein the friction clutch is comprised of a pushing member for applying a pushing force constantly to the friction clutch in the axial direction toward the output rotary member; and
wherein the plurality of elastic members are arranged in a manner such that a net force of the elastic forces thereof is applied homogeneously to the pushing member around the rotational center.

4. The release mechanism as claimed in claim 3,
wherein the pushing member includes a diaphragm spring; and
wherein a load resulting from the hydraulic pressure established by the hydraulic actuator, and the net force of the elastic forces of the elastic members are applied to an inner circumferential portion of the diaphragm spring.

5. The release mechanism as claimed in claim 1,
wherein the plurality of elastic members are arranged in a symmetric manner with respect to a predetermined line extending perpendicular to the rotational center axis.

6. The release mechanism as claimed in claim 3,
Wherein the plurality of elastic members are arranged in a symmetric manner with respect to a predetermined line extending perpendicular to the rotational center axis.
